(19) United States
(12) Patent Application Publication
(10) Pub. No.: US 2022/0028582 A1
(43) Pub. Date: Jan. 27, 2022

(54) HIGH-FREQUENCY COAXIAL CABLE

(71) Applicant: SUMITOMO ELECTRIC INDUSTRIES, LTD., Osaka (JP)

(72) Inventors: Takaaki OKAMOTO, Tochigi (JP); Yuji OCHI, Tochigi (JP); Ryuuta FURUYASHIKI, Tochigi (JP)

(21) Appl. No.: 17/299,892

(22) PCT Filed: Mar. 5, 2020
(86) PCT No.: PCT/JP2020/009455

§ 371 Date: Jun. 4, 2021

(51) Int. Cl. H01B 11/18

(52) U.S. Cl. CPC H01B 11/1808; H01B 1/026

(57) ABSTRACT

A high-frequency coaxial cable used for high-frequency signal transmission includes an inner conductor an insulator surrounding an outer periphery of the inner conductor; a shield conductor surrounding an outer periphery of the insulator and a covering surrounding an outer periphery of the shield conductor, wherein the inner conductor is a compressed conductor having a plurality of silver-plated soft copper element wires compressed.

### TECHNICAL FIELD

The present disclosure relates to a high-frequency coaxial cable.

The present application is based on and claims priority to Japanese Patent Application No. 2019-047870, filed on Mar. 15, 2019, the entire contents of the Japanese Patent Application are hereby incorporated herein by reference.

### BACKGROUND ART

The data transfer speed between electronic devices is increasing day by day.

Accordingly, for cables connecting electronic devices, the required transmission speed and the required frequency band are also increasing.

Thus, as a coaxial cable for performing high-speed transmission at a high-frequency band, there is a known shield cable that includes an inner conductor that is a stranded wire conductor made of tin-plated copper alloy wires, an insulator provided to cover the outer periphery of the inner conductor, and an outer conductor provided to cover the outer periphery of the insulator, wherein the outer conductor includes a first outer conductor covering the outer periphery of the insulator and including a served shield with first element wires iii spirally wound, and a second outer conductor covering the outer periphery of the first outer conductor and including a braided shield with second element wires braided (for example, Patent Document 1).

### PRIOR ART DOCUMENTS

### Patent Documents

[Patent Document 1] Japanese Patent No. 6409993

### SUMMARY OF THE INVENTION

According to one aspect of the present disclosure, a high-frequency coaxial cable used for high-frequency signal transmission includes: an inner conductor; an insulator surrounding an outer periphery of the inner conductor; a shield conductor surrounding an outer periphery of the insulator; and a covering surrounding an outer periphery of the shield conductor, wherein the inner conductor is a compressed conductor having a plurality of silver-plated soft copper element wires compressed.

### BRIEF DESCRIPTION OF THE DRAWINGS

FIG. 1 is a cross-sectional view of a high-frequency coaxial cable according to an embodiment of the present disclosure;

FIG. 2 is an enlarged partial cross-sectional view of the high-frequency coaxial cable according to the embodiment of the present disclosure; and

FIG. 3 is a table summarizing the relationship between Example of the present disclosure and Comparative Examples.

### EMBODIMENT FOR CARRYING OUT THE INVENTION

### Problem to Be Solved by the Present Disclosure

As a characteristic value of evaluating such a coaxial cable for high-speed transmission, skew that is a value defined by the difference in the delay time of two coaxial cables of the same length and the same type is known. Also, the delay time of a coaxial cable is generally determined by three parameters: the outer diameter of the inner conductor; the outer diameter of the insulator, and the capacitance of the coaxial cable.

In Thunderbolt 3, which is one of the high-speed general-purpose data transfer technologies and which has already been put into practical use, the required skew is less than 10 ps/m. In data transfer standards faster than Thunderbolt 3, skew having a value smaller than 10 ps/m is likely to be required.

Therefore, the variation in skew is also required to be smaller than the conventional requirement.

In order to reduce the variation in skew, it is required to reduce the variation in the delay time of coaxial cables. However, because there is little room for adjustment in the outer diameter of the inner conductor and the outer diameter of the insulator due to the restrictions of standards or the like, it is required to reduce the variation in the capacitance of the coaxial cable in order to reduce the variation in skew.

However, because the coaxial cable disclosed in Patent Document 1 uses a stranded wire conductor as the inner conductor, voids are easily generated at random between the inner conductor and the insulator, and it is difficult to suppress the variation in skew.

In view of the above, the present disclosure has an object to provide a high-frequency coaxial cable with a small variation in skew.

### Effect of the Present Disclosure

According to the above, it is possible to provide a high-frequency coaxial cable with a small variation in skew.

### DESCRIPTION OF EMBODIMENTS OF THE PRESENT DISCLOSURE

First, aspects of the present disclosure will be listed and described.

According to one aspect of the present disclosure, (1) a high-frequency coaxial cable used for high-frequency signal transmission includes: an inner conductor; an insulator surrounding an outer periphery of the inner conductor; a shield conductor surrounding an outer periphery of the insulator; and a covering surrounding an outer periphery of the shield conductor, wherein the inner conductor is a compressed conductor having a plurality of silver-plated soft copper element wires compressed.

Thereby, in addition to reducing voids between the silver-plated soft copper element wires and voids between the inner conductor and the insulator, the durability of the inner conductor against repeated stresses is increased. Therefore, it is possible to reduce the variation in skew while maintaining the durability as a cable.

(2) In the high-frequency coaxial cable described above, an outer shape of the inner conductor is circular, and the silver-plated soft copper element wires are composed of a plurality of outer shape forming element wires that form the outer shape of the inner conductor and a core element wire that is in contact with only the outer shape forming element wires, and respective centers of iii virtual circles passing through outer shapes of the outer shape forming element wires toward the insulator match.

Thereby, because voids between the inner conductor and the insulator are further reduced, the variation in capacitance as the high-frequency coaxial cable can be reduced and the variation in skew can be reduced.

(3) In the high-frequency coaxial cable described above, the core element wire of the silver-plated soft copper element wires is hexagonal in a cross-section view, and the outer shape forming element wires are six wires.

Thereby, because the inner conductor has a close-packed structure, voids in the inner conductor are further reduced, and the variation in skew can be further reduced.

(4) In the high-frequency coaxial cable described above, the insulator is made of a fluoropolymer. Thereby, it is possible to easily bend while having heat resistance and oil resistance.

(5) In the high-frequency coaxial cable described above, the shield conductor is formed of a plurality of shield element wires.

Thereby, because the durability of the shield conductor against repeated stresses is increased, the durability as a cable can be increased.

(6) In the high-frequency coaxial cable described above, an outer diameter of the inner conductor is 0.1 mm or more and 0.5 mm or less, and an outer diameter of the insulator is 0.2 mm or more and 2.0 mm or less.

### DETAILS OF EMBODIMENT OF THE PRESENT DISCLOSURE

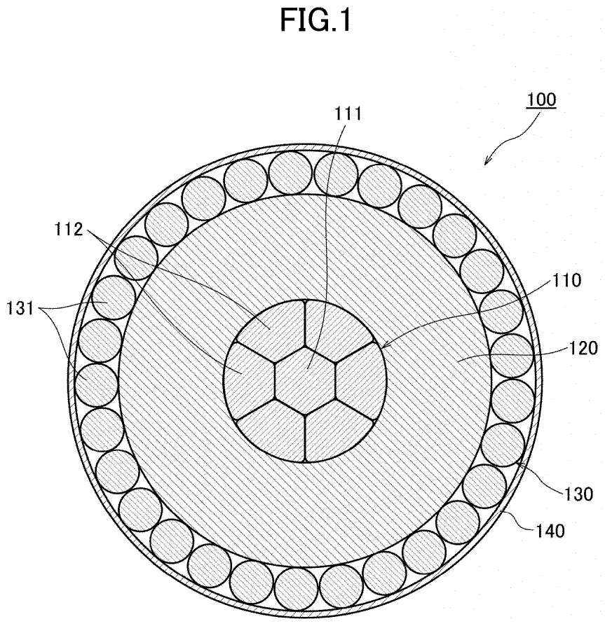

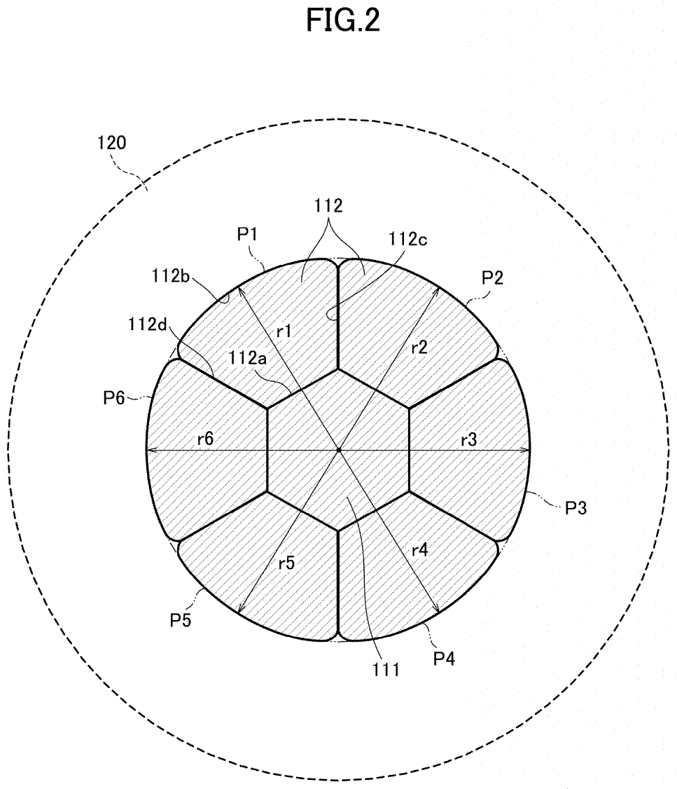

A high-frequency coaxial cable according to an embodiment of the present disclosure will be described with reference to FIG. 1 and FIG. 2.

FIG. 1 is a cross-sectional view of a high-frequency coaxial cable according to an embodiment of the present disclosure, and FIG. 2 is an enlarged partial cross-sectional view of the high-frequency coaxial cable according to the embodiment of the present disclosure.

It should be noted that the present disclosure is not limited to these examples, and is indicated by the scope of claims, and is intended to include all modifications within the meaning and scope equivalent to the scope of claims.

The high-frequency coaxial cable 100 according to the embodiment of the present disclosure is a high-frequency coaxial cable for high-speed data transmission using a high-frequency band with a transmission rate of 40 Gbps and an attenuation frequency band of 35 GHz or the like.

As illustrated in FIG. 1, the high-frequency coaxial cable 100 includes an inner conductor 110, an insulator 120 surrounding the outer periphery of the inner conductor 110, a shield conductor 130 surrounding the outer periphery of the insulator 120, and a covering 140 surrounding the outer periphery of the shield conductor 130.

The inner conductor 110 is a compressed conductor formed by compressing a plurality of silver-plated soft copper wires and has a substantially circular shape as the outer shape.

As illustrated in FIG. 2, the inner conductor 110, which is a compressed conductor, is composed of a core element wire 111 having a hexagonal shape as a cross-sectional shape in a cross-sectional view; and six outer shape forming element wires 112 that are in contact with the respective sides of the core element wire 111 and that form an outer shape of the inner conductor 110.

Accordingly, the core element wire 111, which is a silver-plated soft copper element wire, is in contact with only the outer shape forming element wires 112.

The outer shape forming element wires 112, which are silver-plated soft copper element wires, have a trapezoidal shape as a cross-sectional shape in a cross-sectional view.

This trapezoidal cross-sectional shape is defined by an inner peripheral side 112a that is in contact with the core element wire 111, an outer peripheral side 112b that is opposite to the inner peripheral side 112a and that is in contact with the insulator 120, and a left side 112c and a right side 112d extending in directions toward the insulator 120.

The centers of virtual circles P1, P2, P3, P4, P5, and P6 passing through the outer peripheral sides 112b, which are the outer shapes of the outer shape forming element wires 112 toward the insulator 120, substantially match.

The radii r1, r2, r3, r4, r5, and r6 of the virtual circles P1, P2, P3, P4, P5, and P6 are approximately equal.

The insulator 120 is made of FEP (tetrafluoroethylene-propylene hexafluoride copolymer), i.e., made of a fluoropolymer.

The insulator 120 is coated on the inner conductor 110 by a drawdown molding. Here, because the inner conductor 110 is a compressed conductor, voids between the inner conductor 110 and the insulator 120 are iii very few, and the variation in the composite dielectric constant of the high-frequency coaxial cable 100 can be reduced.

Therefore, the variation in the delay time can be reduced, and the value of skew can be reduced.

The shield conductor 130 is made by transversely winding a plurality of shield element wires 131.

The material of the shield element wires 131 is, for example, hard copper wire.

The covering 140 is composed of a shield layer (not illustrated) that is in contact with the shield conductor 130 and a jacket layer that is in contact with the shield layer.

The shield layer may be, for example, a lap wound copper-deposited polyester tape. The jacket layer may be, for example, a wound polyester tape.

### EXAMPLES

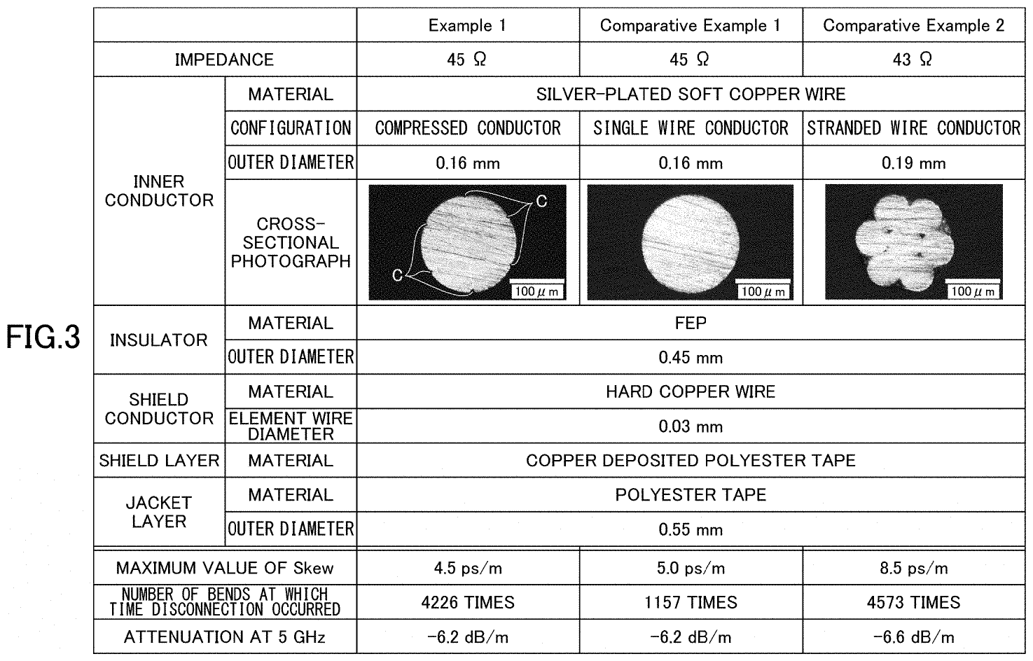

Next, Example of the present disclosure will be described with reference to FIG. 3 that is a table summarizing the relationship between Example of the present disclosure and Comparative Examples.

It should be noted that the Example is merely an example and is not intended to limit the scope of the present disclosure.

### Example 1

A high frequency coaxial cable of Example 1 is an Example of the present disclosure. The inner conductor is a compressed conductor formed by compressing a plurality of silver-plated soft copper element wires and has an outer diameter of 0.16 mm.

The insulator is made of FEP and has an outer diameter of 0.45 mm. Thus, the impedance of the high-frequency coaxial cable of Example 1 is 45Ω.

The shield conductor is made by laterally winding shield element wires of hard copper wires, and the diameter of the shield element wires is 0.45 mm.

The shield layer of the covering is made of a copper deposited polyester tape.

The jacket layer of the covering is made of a polyester tape and the outer diameter of the jacket layer of the covering (that is, the outer diameter of the covering) is 0.55 mm.

### Comparative Example 1

Next, a high-frequency coaxial cable of Comparative Example 1 will be described.

The inner conductor is a single conductor composed of a single silver-plated soft copper element wire and has an outer diameter of 0.16 mm.

The insulator is made of FEP and has an outer diameter of 0.45 mm.

Thus, the impedance of the high-frequency coaxial cable of Comparative Example 1 is 45

The shield conductor is made by laterally winding shield element wires of hard copper wires, and the diameter of the shield element wires is 0.45 mm.

The shield layer of the covering is made of a copper deposited polyester tape.

The jacket layer of the covering is made of a polyester tape and the outer diameter of the jacket layer of the covering (that is, the outer diameter of the covering) is 0.55 mm.

### Comparative Example 2

Next, a high-frequency coaxial cable of Comparative Example 2 will be described.

The inner conductor is a stranded wire conductor formed by twisting seven silver-plated soft copper element wires and has an outer diameter of 0.19 mm.

The insulator is made of FEP and has an outer diameter of 0.45 mm.

Thus, the impedance of the high-frequency coaxial cable of Comparative Example 2 is 43Ω.

The shield conductor is made by laterally winding shield element wires of hard copper wires, and the diameter of the shield element wires is 0.45 mm.

The shield layer of the covering is made of a copper deposited polyester tape.

The jacket layer of the covering is made of a polyester tape and the outer diameter of the jacket layer of the covering (that is, the outer diameter of the covering) is 0.55 mm.

### [Evaluation Method 1: Maximum Value of Skew]

In order to evaluate Example and Comparative Examples described above, electrical pulses were sent to two high-frequency coaxial cables having predetermined lengths by a digital serial analyzer to measure the delay time per 1 m.

From a plurality of samples, the value was obtained by subtracting the minimum delay time from the maximum delay time, and this value is indicated in FIG. 3 as the “MAXIMUM VALUE OF Skew”.

As indicated in FIG. 3, it can be seen that the maximum value of skew of Example 1 (compressed conductor) and the maximum value of skew of Comparative Example 1 (single wire conductor) are smaller than that of Comparative Example 2 (stranded conductor).

### [Evaluation Method 2: The Number of Bends]

In order to evaluate Example and Comparative iii Examples described above, the high-frequency coaxial cable of each example was sandwiched with a mandrel having a mandrel diameter of 2 mm, and with a load of 200 g applied vertically downward, an operation of 90 degrees bending was repeatedly given to the high-frequency coaxial cable.

FIG. 3 indicates the number of bends at which time each high-frequency coaxial cable was broken when the bending operation was continuously given to the high-frequency coaxial cable.

It should be noted that for the “number of bends”, when bending is reciprocated once, it is counted as once.

As indicated in FIG. 3, it can be seen that Example 1 (compressed conductor) and Comparative Example 2 (stranded conductor) have superior flexural durability compared to Comparative Example 1 (single wire conductor).

### [Evaluation Method 3: Attenuation]

In order to evaluate Example and Comparative Examples described above, the attenuation (S parameter S21) at 5 GHz of the high-frequency coaxial cable for each example was measured.

As indicated in FIG. 3, it can be seen that the attenuation of Example 1 (compressed conductor) and the attenuation of Comparative Example 1 (single wire conductor) are smaller than that of Comparative Example 2 (stranded conductor).

### [Comparison of Each Example]

When Example and Comparative Examples described above are evaluated by the evaluation methods 1 to 3, it is confirmed that Example 1 (compressed conductor) is equivalent to Comparative Example (single wire conductor) in the maximum value of skew and the attenuation and has flexural durability similar to that of Comparative Example (stranded wire conductor).

Accordingly, for Example 1, it can be confirmed that both electrical characteristics and mechanical characteristics are achieved, and it can be said that the high-frequency coaxial cable of Example 1 has superior characteristics to the conventional high-frequency coaxial cables.

It should be noted that, in the cross-sectional photograph of the inner conductor, voids were not found inside Example 1. In Example 1, the cross-sectional shape of the core element wire was hexagonal, and the respective outer peripheral sides of the six outer shape forming element wires formed a concentric circle.

Further, constrictions C were identified between the respective outer peripheral sides of the six outer shape forming element wires in Example 1.

### Modified Example

Although the outer shape of the inner conductor was 0.16 mm in Example of the present disclosure, the inner conductor may have an outer shape of 0.1 mm or more and 0.5 mm or less as long as the inner conductor is a compressed conductor.

Although the outer shape of the insulator was 0.45 mm in Example of the present disclosure, the outer shape of the insulator may be 0.2 mm or more and 2 mm or less as long as the impedance of the coaxial cable is in the range of 30Ω to 60Ω.

Although the embodiment of the present disclosure has been described above, the present disclosure is not limited to the above.

Also, each element of the embodiment described above can be combined as far as it is technically possible, and combinations thereof are included within the scope of iii the present disclosure as long as they include features of the present disclosure.

### DESCRIPTION OF THE REFERENCE NUMERALS

100: high-frequency coaxial cable
110: inner conductor
111: core element wire
112: outer shape forming element wire
112a: inner peripheral side
112b: outer peripheral side
112c: left side
112d: right side
120: insulator
130: shield conductor
131: shield wire
140: covering
P1, P2, P3, P4, P5, P6 . . . virtual circle
r1, r2, r3, r4, r5, r6 . . . radius of virtual circle
C: constriction

1. A high-frequency coaxial cable used for high-frequency signal transmission, the high-frequency coaxial cable comprising:
an inner conductor;
an insulator surrounding an outer periphery of the inner conductor;
a shield conductor surrounding an outer periphery of the insulator; and
a covering surrounding an outer periphery of the shield conductor,
wherein the inner conductor is a compressed conductor having a plurality of silver-plated soft copper element wires compressed,
wherein an outer shape of the inner conductor is circular,
wherein the silver-plated soft copper element wires are composed of a plurality of outer shape forming element wires that form the outer shape of the inner conductor and a core element wire that is in contact with only the outer shape forming element wires,
wherein a void is not present inside the inner conductor, and
wherein a construction is provided between respective outer peripheral sides of the outer shape forming element wires.

2. The high-frequency coaxial cable according to claim 1,
wherein respective centers of virtual circles passing through outer shapes of the outer shape forming element wires toward the insulator match.

3. The high-frequency coaxial cable according to claim 2,
wherein the core element wire of the silver-plated soft copper element wires is hexagonal in a cross-section view, and
wherein the outer shape forming element wires are six wires.

4. The high-frequency coaxial cable according to claim 1, wherein the insulator is made of a fluoropolymer.

5. The high-frequency coaxial cable according to claim 1, wherein the shield conductor is formed of a plurality of shield element wires.

6. The high-frequency coaxial cable according to claim 1,
wherein an outer diameter of the inner conductor is 0.1 mm or more and 0.5 mm or less, and
wherein an outer diameter of the insulator is 0.2 mm or more and 2.0 mm or less.

7. The high-frequency coaxial cable according to claim 1,
wherein an outer diameter of the inner conductor is greater than a film thickness of the insulator, and
wherein the shield conductor is composed of a plurality of shield element wires, and a wire diameter of the shield element wires is greater than a film thickness of the covering.
